(19) United States
(12) Patent Application Publication
(10) Pub. No.: US 2008/0219657 A1
(43) Pub. Date: Sep. 11, 2008

(54) Portable Electronic Apparatus

(75) Inventors: Tatsuya Suzuki, Tokyo (JP); Tsuyoshi Fukuta, Tokyo (JP)

Correspondence Address: HOGAN & HARTSON L.L.P., 1999 AVENUE OF THE STARS, SUITE 1400, LOS ANGELES, CA, 90067, US

(73) Assignees: OLYMPUS CORPORATION, Tokyo (JP); OLYMPUS IMAGING CORP., Tokyo (JP)

(21) Appl. No.: 12/100,985

(22) Filed: Apr. 10, 2008

Related U.S. Application Data
(63) Continuation of application No. PCT/JP2007/068483, filed on Sep. 14, 2007.

(30) Foreign Application Priority Data
Sep. 21, 2006 (JP) 2006-255810

(51) Int. Cl. G03B 17/02

(52) U.S. Cl. 396/423

(57) ABSTRACT

A portable electronic apparatus includes an exterior member which has an opening and houses a main body. A part of the main body is exposed through the opening. The apparatus also includes a lid which is attached to the exterior member so as to cover or uncover the opening; and a strap attaching part provided on an area of the part of the main body. The area is covered with the lid, and a strap with a small loop is attachable to the strap attaching part.

### CROSS-REFERENCE TO RELATED APPLICATIONS

This application is a continuation of PCT international application Ser. No. PCT/JP2007/068483 filed Sep. 14, 2007 which designates the United States, incorporated herein by reference, and which claims the benefit of priority from Japanese Patent Application No. 2006-255810, filed Sep. 21, 2006, incorporated herein by reference.

### BACKGROUND OF THE INVENTION

1. Field of the Invention

The present invention relates to a small portable electronic apparatus.

2. Description of the Related Art

Small portable electronic devices, such as digital cameras, mobile phones, and digital voice recorders, have strap attaching parts to which straps are attached. Such a device is hung from user's hand, neck, or shoulder through a strap to prevent the device from falling. The strap attaching part is typically provided on the surface of the small portable electronic device. For example, refer to Japanese Patent Application Laid-open Nos. 2003-84358, 2003-273529, 2003-295279, 2004-258220, and 2006-39332.

### SUMMARY OF THE INVENTION

A portable electronic apparatus according to an aspect of the invention includes an exterior member which has an opening and houses a main body, a part of the main body being exposed through the opening; a lid which is attached to the exterior member so as to cover or uncover the opening; and a strap attaching part provided on an area of the part of the main body, the area being covered with the lid, a strap with a small loop being attachable to the strap attaching part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of the structure of a portable electronic apparatus, herein exemplified as a digital camera, according to a first embodiment of the present invention;

FIG. 2 is a relevant bottom perspective view of the structure of the portable electronic apparatus, herein exemplified as the digital camera, according to the first embodiment of the present invention;

FIG. 3 is a view of the structure shown in FIG. 2 with a lid opened;

FIG. 4 is a perspective view of the structure of a portable electronic apparatus, herein exemplified as a digital camera, according to a second embodiment of the present invention; and

FIG. 5 is a view of the structure shown in FIG. 4 with a lid opened.

### DETAILED DESCRIPTION OF THE PREFERRED EMBODIMENTS

The best modes for carrying out the present invention, hereinafter referred to as embodiments, are described below with reference to the attached drawings. The figures are merely schematic diagrams, and thus, when the same components are shown in different figures, their dimensions and scales may differ.

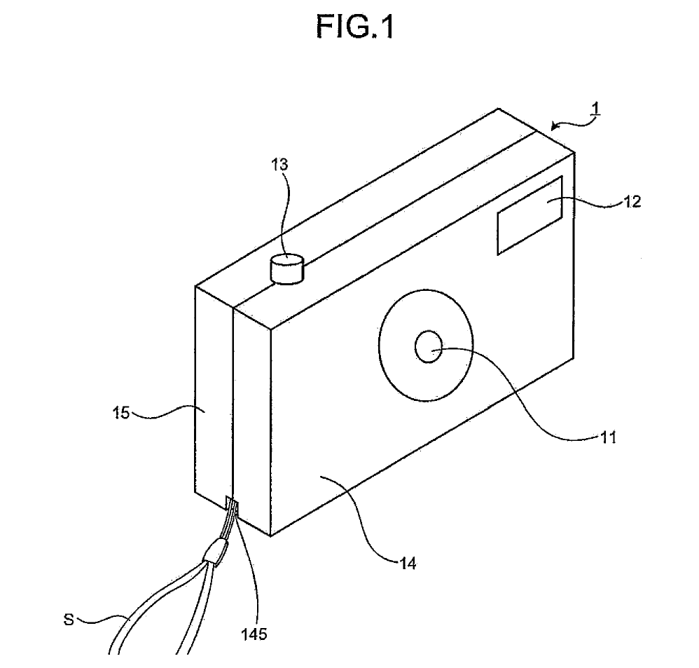

FIG. 1 is a perspective view of an exterior structure of a digital camera, which is a portable electronic apparatus according to a first embodiment. A digital camera 1 shown in FIG. 1 generates image data in such a way that light collected and focused through a taking lens is subjected to photoelectrical conversion to be an electric signal, and the electric signal is subjected to a prescribed image processing. The digital camera 1 includes an image pickup unit 11 having the taking lens; a flashbulb 12 for strobe lighting; a shutter release button 13 which may be pressed while taking a picture; and two covering members 14 and 15 constituting the exterior member which houses the main body of the digital camera 1. A strap S is attached to a prescribed portion of the digital camera 1 shown in FIG. 1.

The main body of the digital camera 1 includes electronic components (not shown), which achieve various functions such as image pickup process, and the electronic components include a control circuit comprising a CPU (Central Processing Unit) and the like to control the drive of the digital camera 1; a solid-state image sensing device such as CCD (Charge Coupled Device) or CMOS (Complementary Metal Oxide Semiconductor); a microphone for audio input and a speaker for audio output; and a drive circuit which drives functional components under the control of the control circuit. Provided is a display unit, e.g., an LCD (Liquid Crystal Display) to display image and textual information, operation buttons used for inputting the necessary information for operation of the digital camera 1, and others (not shown) on a rear side opposite to a front side on which the image pickup unit 11 is exposed.

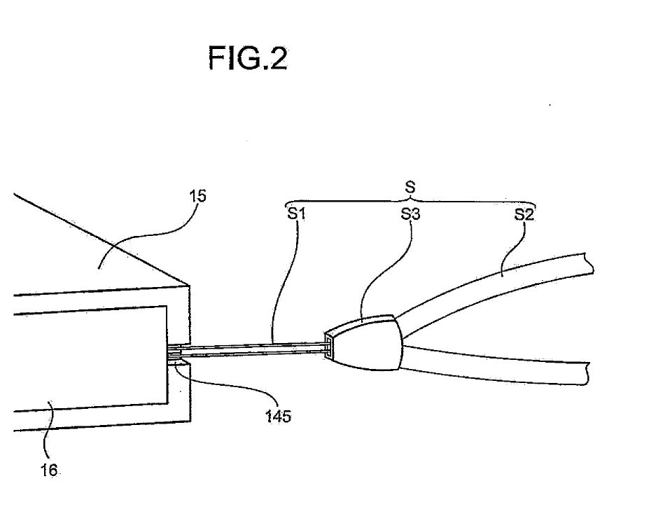

FIG. 2 is a relevant bottom respective view of the structure of the digital camera 1. The term “bottom” is used to mean a side opposite to the side on which the shutter release button 13 is exposed (referred to as the top side). A lid 16 is provided at the bottom of the digital camera 1, covering an opening of the exterior member, i.e., the covering members 14 and 15. The lid 16 has a rectangular shaped surface, and rotates around the rotational axis which is near the short side on the left in FIG. 2 to be opened and closed. This opening and closing mechanism can be achieved by, for example, providing a hinge on the short side of the lid. The lid 16 shown in FIG. 2 is locked with a prescribed locking mechanism (not shown).

The strap S has a small loop S1 which is to be attached to the digital camera 1, a large loop S2 through which a part of the user's body, e.g., a hand is put, and a connecting part S3 which connects the small loop S1 and the large loop S2. A hand strap, a neck strap, and a shoulder strap, the large loops S2 of which are put through a hand, a neck, and a shoulder, respectively, and the like, are examples of the strap S.

The small loop S1 is leading out through a groove-like slot 145 which is formed at an area including a border between the covering members 14 and 15. Therefore, an end portion of the small loop S1 is covered by the lid 16 with the lid 16 closed, and thus is not seen from outside of the digital camera 1 (refer to FIG. 1 and FIG. 2).

The slot 145 shown in FIG. 2 is just an example. A hole which allows the small loop S1 to be put therethrough may be formed at a suitable position of the exterior member, to be used as the slot.

In the first embodiment, since the slot 145, through which the small loop S1 is led out, is formed around a ridge line bounding the bottom and a literal side of the digital camera 1, the strap S will not come into contact with, for example, the user's palm while the user holds the digital camera 1. Therefore, the user can concentrate on taking pictures without discomfort caused by the contact with the strap.

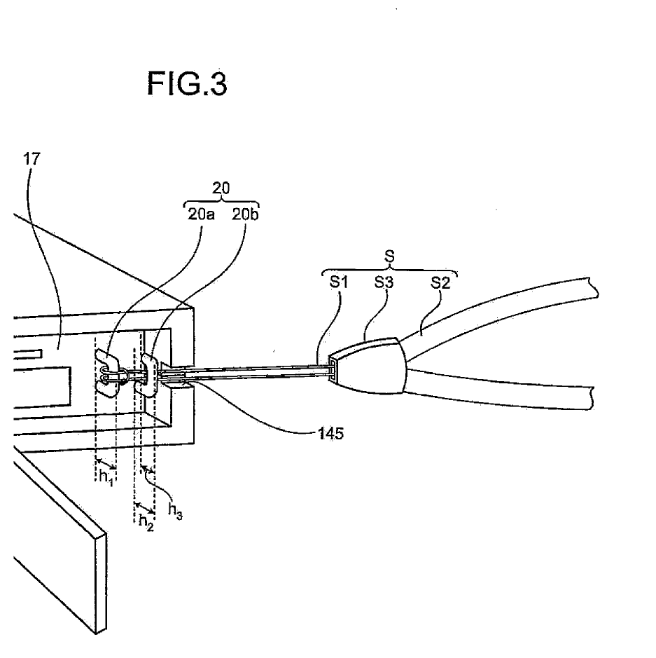

The structure of a portion covered by the lid 16 is described below. FIG. 3 shows a situation with the lid 16 opened, and how the strap S is attached to the main body. As shown in FIG. 3, a recess 17, which is a portion of the main body, is formed in the area covered by the lid 16. Loading slots 18 and 19 for a portable storage medium such as a flash memory and a battery such as a lithium ion battery, respectively, and a strap attaching part 20 to which the strap S is attached, are provided on a bottom of the recess 17.

The strap attaching part 20 has a tied part 20a with which the small loop S1 is tied, and a guiding part 20b which guides the small loop S1 to the slot 145. The tied part 20a is formed from a U-shaped bar member whose both ends are connected to the bottom of the recess 17. The guiding part 20b is formed from a U-shaped bar member whose one end is connected to the bottom of the recess 17, and there is a gap between the other end of the U-shaped bar member and the bottom of the recess 17. The tied part 20a and the guiding part 20b are preferably made of highly rigid metal or resin.

Suppose that the height of the tied part 20a measured from the bottom of the recess 17 is hi; the height of the guiding part 20b measured from the bottom of the recess 17 is h₂, and the height of the guiding part 20b measured from the end which is not connected to the bottom of the recess 17 is h₃; h₂>h₃ is always true in respect of h₂ and h₃. On the other hand, the magnitude relations between h₁ and h₂, and between h₁ and h₃, are set based on conditions such as the shape of the covering members 14 and 15, the shape of the lid 16, the positional relationships between these parts, and the depth of the recess 17, accordingly.

A part of the small loop S1, which is closer to the connecting part S3 than a knot where the small loop S1 is tied, is hooked on the guiding part 20b through the gap between the unconnected end of the guiding part 20b and the bottom of the recess 17. When the small loop S1 is hooked on the guiding part 20b, the movement of the small loop S1 is restricted by the guiding part 20b.

More specific description of the function of the guiding part 20b will be given below. In FIG. 3, the axial direction of the rotational axis of the lid 16 is substantially parallel to the axial direction of the tied part 20a with which the strap S is tied by its knot (the extending direction of the base portion of the U-shaped bar member). Therefore, without the guiding part 20b, the lid 16 may be opened when the strap S is pulled in substantially the same direction as the direction in which the lid 16 may open. In the first embodiment, since the guiding part 20b is provided as described above, the lid 16 is prevented from being opened due to the strap S pulled by the user.

The position at which the guiding part 20b is provided may be set based on the conditions such as the shape of the covering members 14 and 15, the shape of the lid 16, the positional relationships between these parts, and the depth of the recess 17, accordingly, as well as the magnitude relation between h₁ and h₂ described above.

The strap attaching part 20 having the structure described above may be integrally formed with the bottom of the recess 17, or may be formed as a separate part to be provided on the bottom of the recess 17. The tied part 20a and the guiding part 20b are not limited to being of U-shape, and may be, for example, a bar connecting both inner wall surfaces of the recess 17.

Since FIG. 2 and FIG. 3 are focused on describing how to attach the strap S to the digital camera 1, specific descriptions of the structure on the surface of the covering member 15, which is the structure of the rear side of the digital camera 1, the method for connecting the covering members 14 and 15, and others are omitted. Parts not described above may be the same as those of the conventional digital cameras.

The portable electronic apparatus (a digital camera) according to the first embodiment described above includes: the exterior member which houses the main body and has the opening, the part of the main body being exposed through the opening; the lid which is attached to the exterior member so as to cover or uncover the opening; and the strap attaching part provided on the area of the main body, the area being covered by the lid, the strap with the small loop being attachable to the strap attaching part. Accordingly, the portable electronic apparatus can keep its usability even when the strap is attached thereto, without spoiling the beauty of the apparatus.

According to the first embodiment, the attached strap is led out through the vicinity of the ridge line on the bottom of the substantially rectangular exterior member. Therefore, the portable electronic apparatus allows the user to concentrate on taking pictures without the disturbance of the strap while the user holds the digital camera.

Moreover, according to the first embodiment, since the strap attaching part is covered by the lid and is not seen from outside, users who do not use straps can escape caring about the strap attaching part.

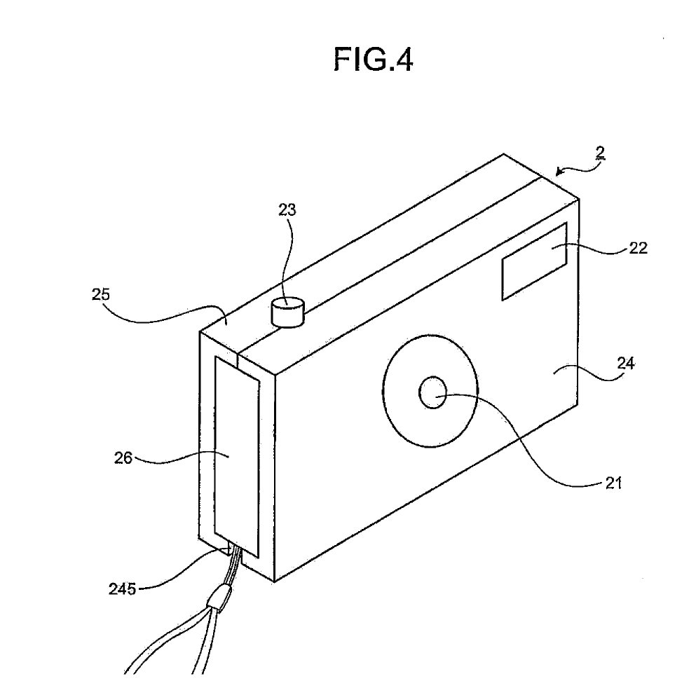

FIG. 4 is a perspective view of an exterior structure of a digital camera which is a portable electronic apparatus according to a second embodiment. A digital camera 2 shown in FIG. 4 includes an image pickup unit 21, a flashbulb 22, a shutter release button 23, and two covering members 24 and 25. The structure of a rear side of the digital camera 2 in FIG. 4 and a functional structure of its main body, which is not shown, are the same as those of the digital camera 1 according to the first embodiment.

The exterior member, which includes the covering members 24 and 25 and houses the main body of the digital camera 2, has an opening on its lateral side. The term “lateral side” is used to mean a side which intersects both with a front side on which the image pickup unit 21 is provided and with a top side on which the shutter release button 23 is provided. In the case of FIG. 4, the lateral side is orthogonal to both the front side and the top side. A lid 26, which covers or uncovers the opening, is provided on the lateral side of the exterior member having the opening. The lid 26 has a rectangular surface and rotates around the rotational axis which is near the long side on the left in FIG. 4 to be opened and closed. This opening and closing mechanism can be achieved by, for example, providing a hinge on the long side of the lid. The lid 26 shown in FIG. 4 is locked with a prescribed locking mechanism (not shown).

A strap S, which is attached to the digital camera 2, is led out from the digital camera 2 through a slot 245 which is formed at an area including a border between the covering members 24 and 25. Therefore, an end portion of the small loop S1 is covered by the lid 26 with the lid 26 closed, and thus is not seen from outside of the digital camera 2.

In the second embodiment, since the slot 245 is formed in vicinity of the ridge line bounding a bottom and a lateral side of the digital camera 2, the strap S will not come into contact with, for example, the user's palm while the user holds the digital camera 2. Therefore, the user can concentrate on taking pictures without discomfort caused by the contact with the strap.

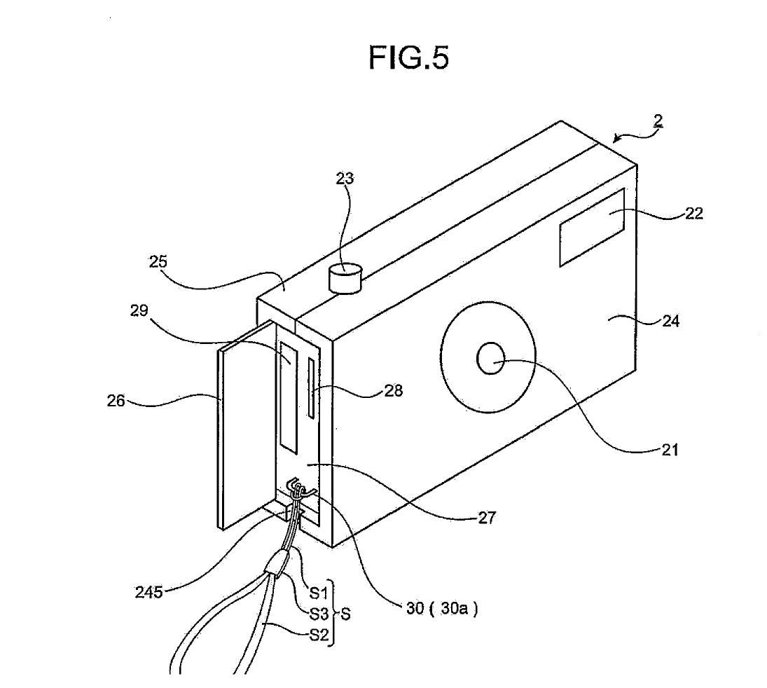

The specific structure of a portion covered by the lid 26 is described below. FIG. 5 shows a situation with the lid 26 opened, and how the strap S is attached to the main body. As shown in FIG. 5, a recess 27, which is a portion of the main body of the digital camera 2, is formed in the area covered by the lid 26. Loading slots 28 and 29 for a portable storage medium and a battery, respectively, and a strap attaching part 30 to which the strap S is attached, are provided on a bottom of the recess 27.

The strap attaching part 30 has a tied part 30a with which the small loop S1 is tied. In FIG. 5, the tied part 30a is formed from a U-shaped bar member whose both ends are connected to the bottom of the recess 27. In the digital camera 2, the axial direction of the rotational axis of the lid 26 is substantially orthogonal to the axial direction of the tied part 30a with which the strap S is tied by its knot (the extending direction of the arms of the U-shaped bar member). Accordingly, even if the user pulls the strap in any direction, the lid 26 is not opened. Therefore, according to the second embodiment, since the movement of the small loop S1 need not to be restricted, there is no necessity of providing a part corresponding to the guiding part 20b of the strap attaching part 20 of the first embodiment.

The portable electronic apparatus according to the second embodiment described above (a digital camera) can keep its usability even when the strap is attached thereto, without spoiling the beauty of the apparatus, as in the first embodiment. Besides, the portable electronic apparatus allows the user to concentrate on taking pictures without the disturbance of the strap while the user holds the digital camera. Moreover, users who do not use straps can escape caring about the strap attaching part.

According to the second embodiment, since the axial direction of the rotational axis of the lid is substantially orthogonal to the tied part with which the strap is tied by the knot. Accordingly, even if the user pulls the strap in any direction, the lid is not opened. Therefore, the number of parts constituting the strap attaching part can be kept to a minimum.

The first embodiment and the second embodiment are described above in detail as the best modes for carrying out the invention. However, the present invention is not limited to these two embodiments. The portable electronic apparatuses according to the present invention may be, for example, various portable cameras other than digital cameras, portable communication terminals such as mobile phones, PHSs (Personal Handyphone Systems) and PDAs (Personal Digital Assistants), portable audio devices, digital voice recorders, portable radios, remote controllers for various home electric appliances, digital video recorders, and the like.

In the case where the portable electronic apparatus according to the present invention has such a structure that a lid covers an interface for connection with the external device, including a DC input terminal and a USB (Universal Serial Bus) terminal, the strap attaching part may be provided on an area of the interface covered.

The strap attached to the portable electronic apparatus according to the present invention has only to have a small loop for attachment. For example, even an ornamental strap with an ornamental member connected to the connecting part may be used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable electronic apparatus comprising:
an exterior member which houses a main body and has an opening, a part of the main body being exposed through the opening;
a lid which is attached to the exterior member so as to cover or uncover the opening; and
a strap attaching part provided on an area of the main body, the area being covered by the lid, a strap with a small loop being attachable to the strap attaching part.

2. The portable electronic apparatus according to claim 1, wherein the exterior member has a slot through which the strap attached to the strap attaching part is led out of the exterior member.

3. The portable electronic apparatus according to claim 1, wherein the strap attaching part has a tied part with which the small loop of the strap is tied.

4. The portable electronic apparatus according to claim 3, wherein the strap attaching part has a guiding part which restricts the movement of the small loop tied with the tied part and which guides the small loop to the slot.
